(19) United States
(12) Patent Application Publication
(10) Pub. No.: US 2007/0198472 A1
(43) Pub. Date: Aug. 23, 2007

(54) MULTIMEDIA SYSTEM FOR A VEHICLE

(75) Inventors: Craig Simonds, Dearborn, MI (US); David Kowalski, Toledo, OH (US); Frank Perry, Brownstown, MI (US); Nicholas John Ridler, Kenilworth, Warwickshire (GB)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/276,215

(22) Filed: Feb. 17, 2006

(51) Int. Cl. G06F 17/30

(52) U.S. Cl. 707/3

(57) ABSTRACT

The present invention provides a multi-media system and method for a vehicle that enables a user to access content on a device. A user interface is included that is operable with the vehicle and adapted to receive a query command, wherein the query command is received in a predetermined form. Additionally, the user interface provides corresponding query results to the user. A controller is operable with the user interface and is configured to communicate with the device. The controller, in response to the query command, searches accelerator files containing data pertaining to the content. The controller also locates accelerator files that correspond with the query command and provides a corresponding accelerator file data to the user interface.

### TECHNICAL FIELD

The present invention relates to a multi-media system and method for a vehicle that enables a user to access portable device content using interactive vehicle controls.

### BACKGROUND

Consumer electronic devices are capable of storing hundreds and even thousands of files. The type of files stored on the electronic devices may include voice, audio, data and the like. These devices may be portable, thereby providing the user added convenience in accessing the files. Although the convenience in file access has improved, there exists a wide horizon for improvement.

Particularly, users desire to access content located on these devices while in a vehicle. However, with conventional multi-media systems, a query of the content on the device requires a search of substantially all files located on the device. In the case of devices having hundreds and even thousands of files, executing a query is burdensome on the processing power of the vehicle and time consuming. Additionally, in the environment of a vehicle, driving is the primary priority. Accordingly, time consuming searches of data located on the device is distracting and hence undesirable to vehicle occupants, particularly the driver. As such, there is a need for a multi-media system that enables efficient search and retrieval of information on a device.

The present invention was conceived in view of these and other disadvantages of conventional multi-media systems.

### SUMMARY

The present invention provides a multi-media system and method for a vehicle that enables a user to access content on a device. The system includes a user interface that is operable with the vehicle and adapted to receive a query command, wherein the query command is received in a predetermined form. Additionally, the user interface provides corresponding query results to the user. A controller is included that is operable with the user interface and is configured to communicate with the device. The controller, in response to the query command, searches accelerator files containing data pertaining to the content. The controller also locates accelerator files that correspond with the query command and provides a corresponding accelerator file data to the user interface.

The method includes receiving a query command through the use of the user interface, wherein the user interface is operable with the vehicle and the query command is received in a predetermined form. The method further includes searching the accelerator or media files containing data pertaining to the content and locating the accelerator files that correspond with the query command. The method also includes providing the corresponding accelerator file data to the user interface and providing the query results to the user.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may be best understood with reference to the following description, taken in connection with the accompanying drawings in which:

FIG. 1 illustrates an exemplary vehicle that is communicative with a device through the use of a multimedia system in accordance with an embodiment of the present invention;

FIGS. 2-7 illustrate various embodiments of a user interface in accordance with embodiments of the present invention;

FIG. 8 is a flowchart illustrating a method of operation for a multimedia system in accordance with an embodiment of the present invention; and

FIGS. 9-11 illustrate detailed flowcharts of various steps illustrated in FIG. 8 in accordance with embodiments of the present invention.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular proponents. Therefore, specific functional details disclosed herein are not to be interpreted as limiting, but merely as a representative basis for the claims and/or as a representative basis for teaching one skilled in the art to variously employ in the present invention.

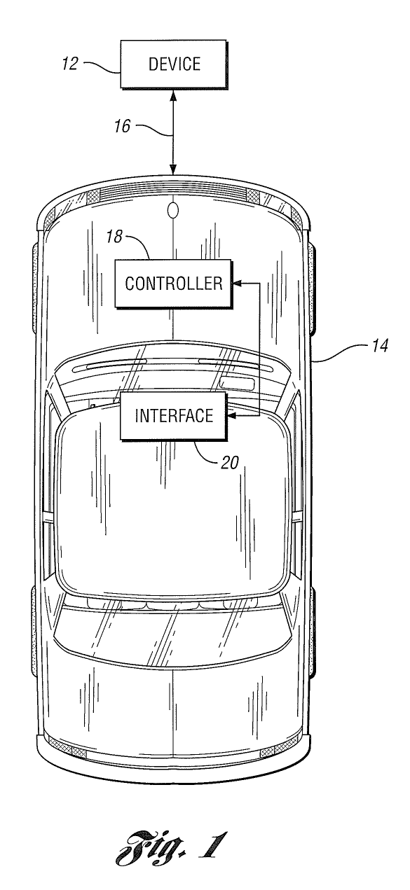

Referring to FIG. 1, a vehicle 14 and a device 12 are shown. The vehicle 14 is configured to communicate with device 12 through the use of a communications line 16, which may be embodied as a cable that is connected to a port within vehicle 14. Alternatively, device 12 may communicate with vehicle 14 via wireless communications protocols such as infrared, Bluetooth, and WI-FI. Device 12 may be any device capable of providing audio, video, data and the like (hereinafter referred to as content). As such, device 12 may be, for example, a hand-held device including an Apple iPod, an iPaq pocket PC, and the like.

Vehicle 14 includes a controller 18 that communicates with a user interface 20. As recognized by one of ordinary skill, controller 18 has data processing capabilities as well as volatile and non-volatile memory. Controller 18 enables communications between device 12 and vehicle 14 by processing signals received from device 12. Additionally, controller 18 is adapted to generate signals in response to inputs from user interface 20 that are received by device 12. Interface 20 may be a graphical user interface that is located on the instrument panel of a vehicle. As such, interface 20 may include a touchscreen that enables a user to enter various commands by touching certain areas of interface 20.

Controller 18 and interface 20, which may be referred to as multimedia system, enables a user to access content located on device 12. Particularly, the user may input various commands that are processed and executed via controller 18 and device 12. As will be described hereinafter, in some instances the multimedia system (e.g., controller 18 and interface 20) may create, store, and retrieve files located on controller 18 and/or device 12.

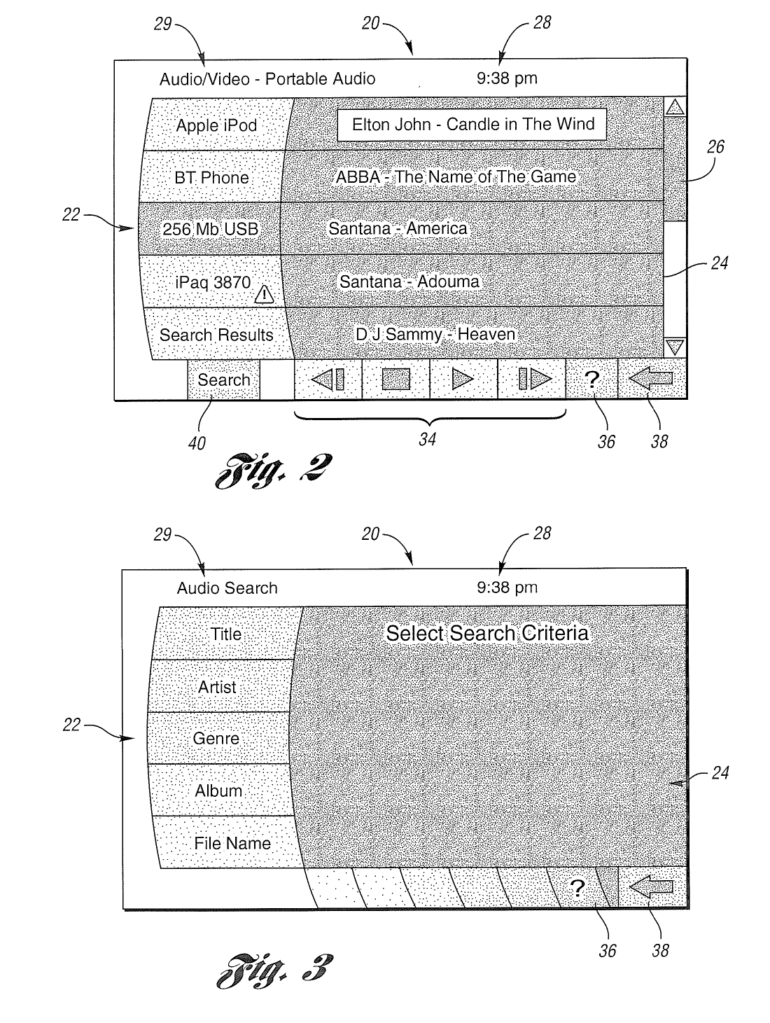

Now referring to FIGS. 2-7, various embodiments of interface 20 are illustrated. Specifically referring to FIG. 2, interface 20 may include a menu 22. Dependent upon the operating mode of the multimedia system as indicated by a mode indicator 29, menu 22 includes corresponding selections. As shown, mode indicator 29 indicates audio/video-portable audio. Consequently, menu 22 includes a list of devices that are connected to the multimedia system. Menu 22 also includes a “search results” button that enables a user to search the results of a query. A display area 24 displays information relevant to menu 22. In one embodiment, once a device is connected to the vehicle multimedia system, display area 24 displays files located on the connected device. For example, as shown in FIG. 2, display area 24 includes a list of files that are located on the device “256 Mb USB,” which, in this embodiment, has been selected by a user. Additionally, the user may select an item from the list of files displayed by display area 24. In the illustrated example, the audio file “Elton John-Candle In The Wind” has been selected. Following the selection of an item from display area 24, the user may select various function buttons 34 that enable the user to playback a file such as an audio, video, e-mail, and the like. A scroll bar 26 also enables the user to scroll through the choices displayed in display area 24.

A search button 40 may be included that allows the user to search a device selected from menu 22. Particularly, contacting search button 40 launches an alternative screen (FIG. 3) that corresponds to specific search functions. Interface 20 may also include a clock 28 and a help button 36. A back button 38 allows the user to access previous screens when selected by the user.

Now referring to FIG. 3, interface 20 is shown in a search mode as indicated by mode indicator 29. It is recognized, that although the mode indicator indicates an audio search mode, the present invention enables the search of other content including, but not limited to, video, e-mails, data, and the like. Menu 22 displays a corresponding list of criteria in which to execute a search. Particularly, the user may elect to search the device content by title, artist, genre, album, or file name. It is recognized that the criteria shown in FIG. 3 is by example only and is not intended to include all possible search criteria. As shown in FIG. 3, display area 24 includes instructions for the user to select a search criteria from menu 22. As described in the foregoing, a user may make a selection from menu 22 by touching or contacting the specific selection within menu 22.

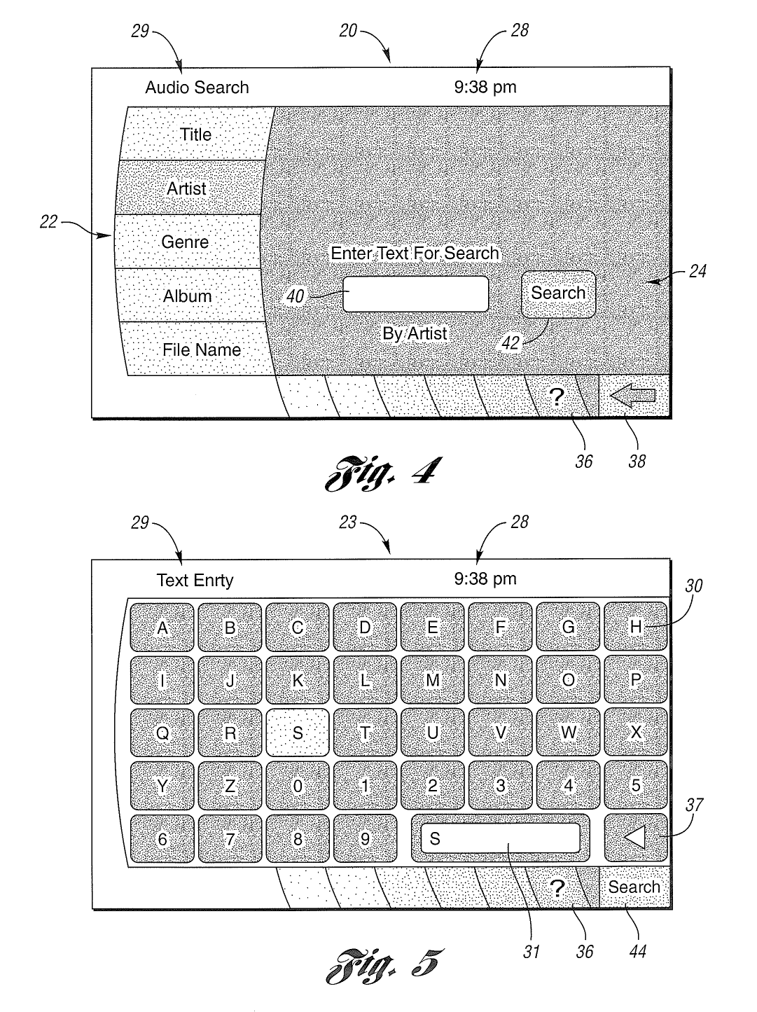

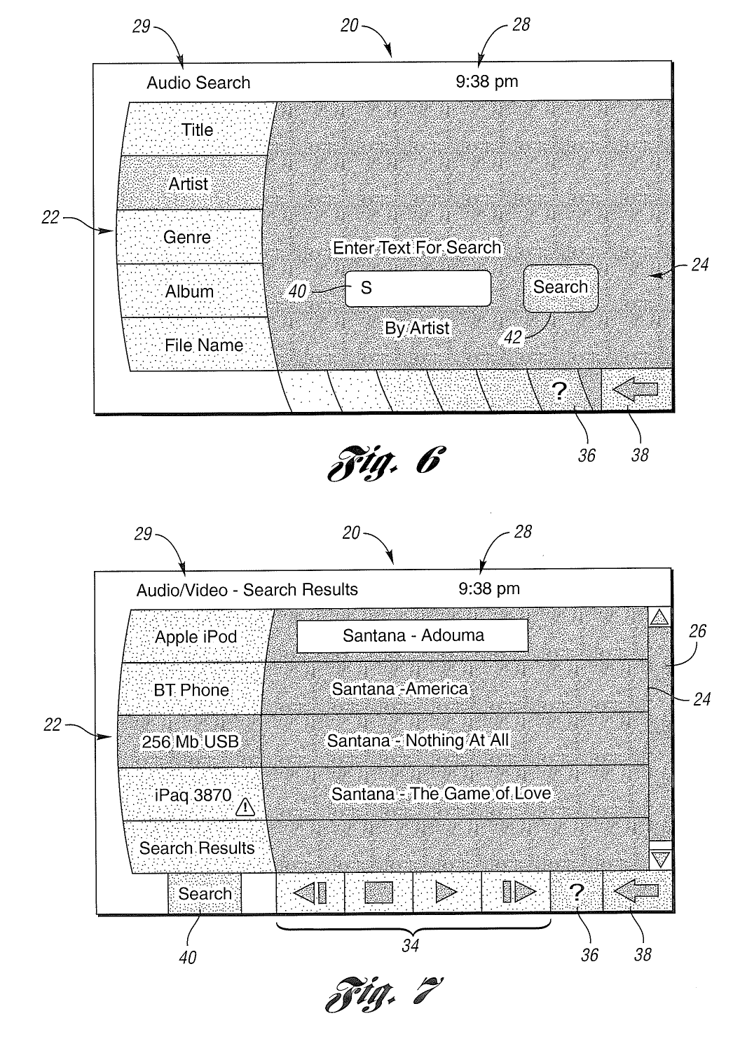

Referring to FIG. 4, the item “Artist” has been selected. Based on the selection, a text box 40 and a search button 42 are displayed within display area 24. Text entry box 40 will be populated with a query command such as keywords or characters as determined by the user. FIG. 5 illustrates a text entry screen 23 that may appear momentarily following interface 20 of FIG. 4. Text entry screen 23 enables the user to choose specific characters 30 upon which to execute a search or query command. In one embodiment, the selected characters will populate text box 40 (FIG. 4) as described below. In FIG. 5, a text entry box 31 is shown that is populated as the user selects characters 30. In the embodiment shown, the character 30 selected by the user is “S.” As such, text box 31 is populated with an “S.” A delete button 37 allows a user to delete selected characters. Once the user completes the entering of characters 30 into text box 31, the user may select a search button 44. Selection of search button 44 causes population of text box 40 as shown in FIG. 6. Accordingly, the user may select search button 42 (FIGS. 4 and 6) to execute the search.

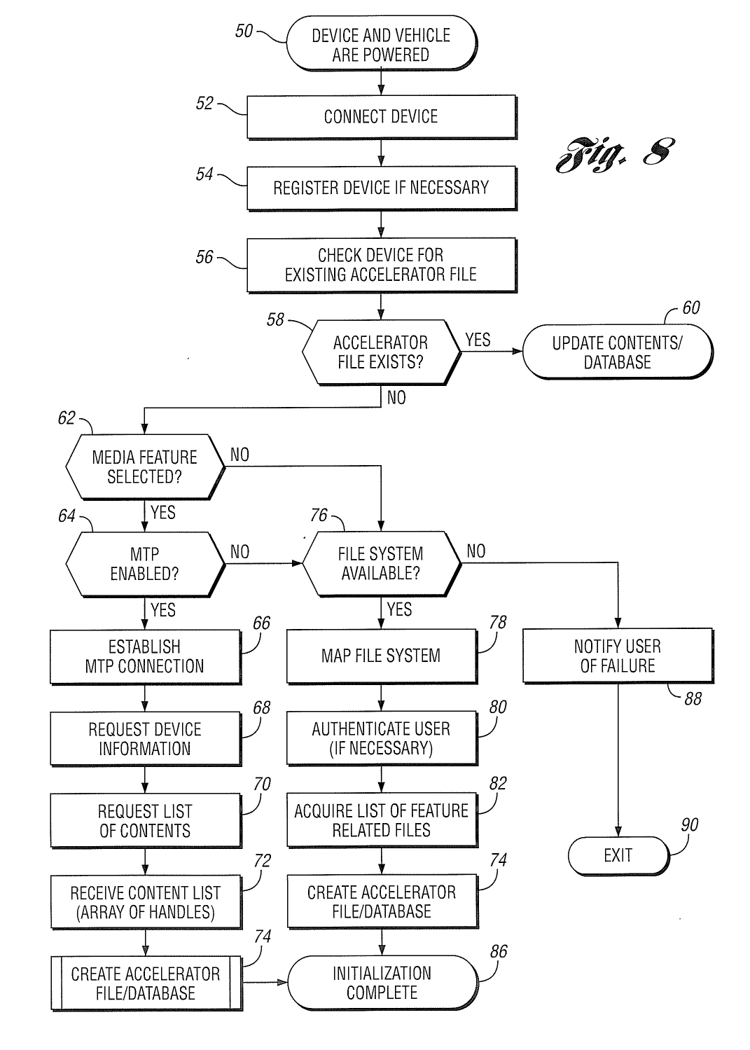

FIG. 7 illustrates interface 20 in the search results mode. Particularly, display area 24 includes a list of items that correspond with the entered query command. The user may then select a specific choice from the list shown in display area 24. In FIG. 7, the item entitled “Santana-Adouma” has been selected. As such, the user may select various function buttons 34 to play, rewind, or fast-forward the selected item. In alternative embodiments, interface 20 may include a speaker that enables the user to audibly receive the search results. In such a case, distraction to the user while in the vehicle is minimized.

Now, an exemplary description of the receipt and execution of a query command to access content located on the device will be described. When the device is connected to the vehicle, an initialization of the device occurs. During initialization, a connectivity configuration is established and stored in the controller's non-volatile memory. This may also be referred to as device registration. Next, a database or accelerator file may be created which links the file names and associated metadata to specific files or content on the device. This accelerator file may be temporarily stored in memory, written to non-volatile memory of the controller, or written to the device. Once the accelerator files for the content are stored, the content on the device may be accessed in an efficient manner.

Particularly, when a user enters a query command and executes a search, the multimedia system is not required to open each file located on the device to identify the corresponding files or content. In executing the search based on the query command, the multimedia system accesses the accelerator files, which expedites searching and improves usability in a vehicle environment. In one embodiment, the accelerator file is a flat-text file. Additionally, the accelerator files contain information that pertains to the content located on a device. In one embodiment, the content located on the device includes files partitioned into segments. In such an embodiment, the files include a header segment. As such, the multimedia system, in creating the accelerator file, reads the header from each file and creates the corresponding accelerator files.

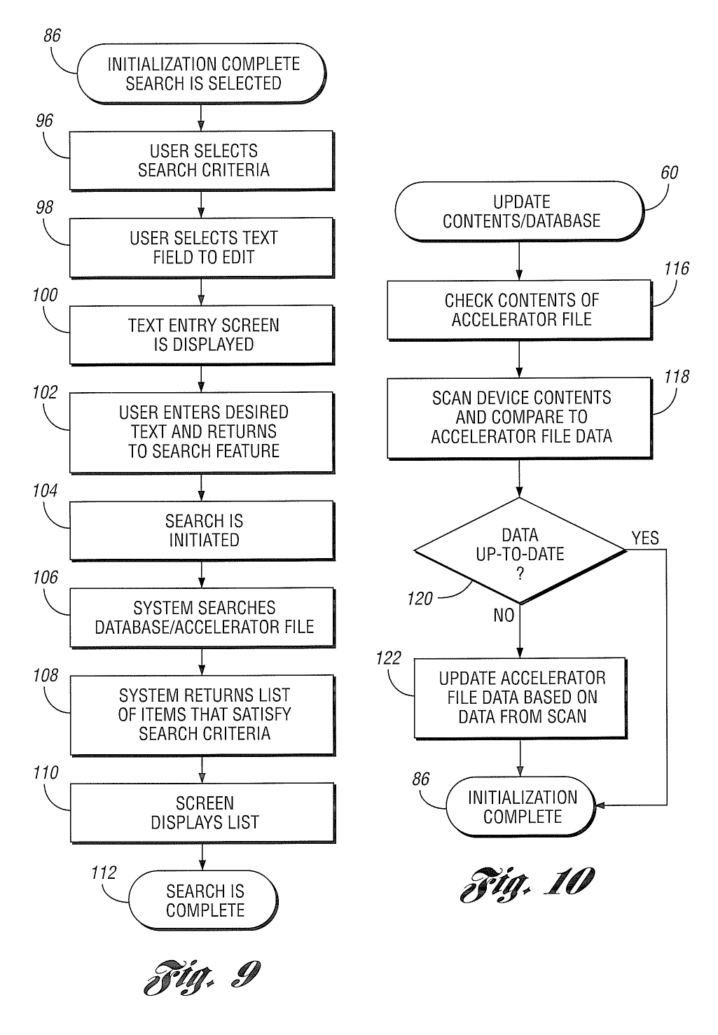

Now, referring to FIGS. 8-11, several flowcharts illustrate a method of operation for the multimedia system that enables access to content located on the device. Particularly, referring to FIG. 8, at block 50, the device and the vehicle are powered. At block 52, the device is connected to the vehicle. At block 54, the device is registered if necessary. It is recognized that a device that has been previously connected and registered does not require subsequent registration when subsequently connected to the vehicle. Block 56 illustrates the device being checked for any existing accelerator files.

At block 58, the method determines whether any accelerator files exist. If accelerator files exist, the contents of the accelerator file or database will be updated as depicted by block 60. Block 60 will be described in further detail hereinafter.

If no accelerator files exist, a block 62 occurs, wherein the method determines whether a media feature has been selected. If a media feature has been selected, the method determines whether the device is enabled by a media transfer protocol (MTP), for example. In one embodiment, the MTP enables media in various formats including Windows Media Audio (WMA), Windows Media Video (WMV), and the like. If the device is MTP enabled, the method establishes an MTP connection as depicted by block 66. At block 68, the method requests information from the device. At block 70, the method, via the controller, requests a list of the content on the device. At block 72, the requested content list is received. In one embodiment, the content list is received in an array-of-handles. It is recognized that an array-of-handles may be an array with entries that are handles to objects of the same type in consecutive locations in the array. At block 74, the method creates the accelerator file or database. Creation of the accelerator file will be described in further detail hereinafter.

Referring back to block 62, if the media feature is not selected, a block 76 occurs wherein the method determines whether a file system is available. If a file system is available, the method maps the file system at block 78. At block 80, the method may authenticate the user. At block 82, the method acquires a list of feature related files. As depicted by block 74, the method creates the accelerator file/database. Once the accelerator file is created at block 74, the initialization is complete as depicted by block 86 and the user may begin entering query commands to execute the search for device content. Block 86 will be described in further detail hereinafter.

Referring back to block 76 in FIG. 8, if the file system is not available the user is notified of a system failure as indicated by block 88. Accordingly, the method exits the initialization as depicted by block 90.

Referring to FIG. 9, a detailed flowchart of the search or query feature is illustrated. As shown by block 86, the initialization has been completed and a search is initiated. At block 96, the user selects a search criteria. In the case of an audio feature, the search criteria may include title, genre, artist, album, or file name. At block 98, the user selects a text field to edit. As depicted by block 100, a text entry screen is displayed. As depicted by block 102, the user enters the desired texts and returns to the search feature. Block 104 illustrates the initialization of the search. Accordingly, at block 106, the system searches the database or accelerator file based on the query command. Block 108 depicts the system returning a list of items that satisfy the search criteria (i.e., query results). At block 110, the interface displays the list on the screen. Accordingly, the search is completed as depicted by block 112.

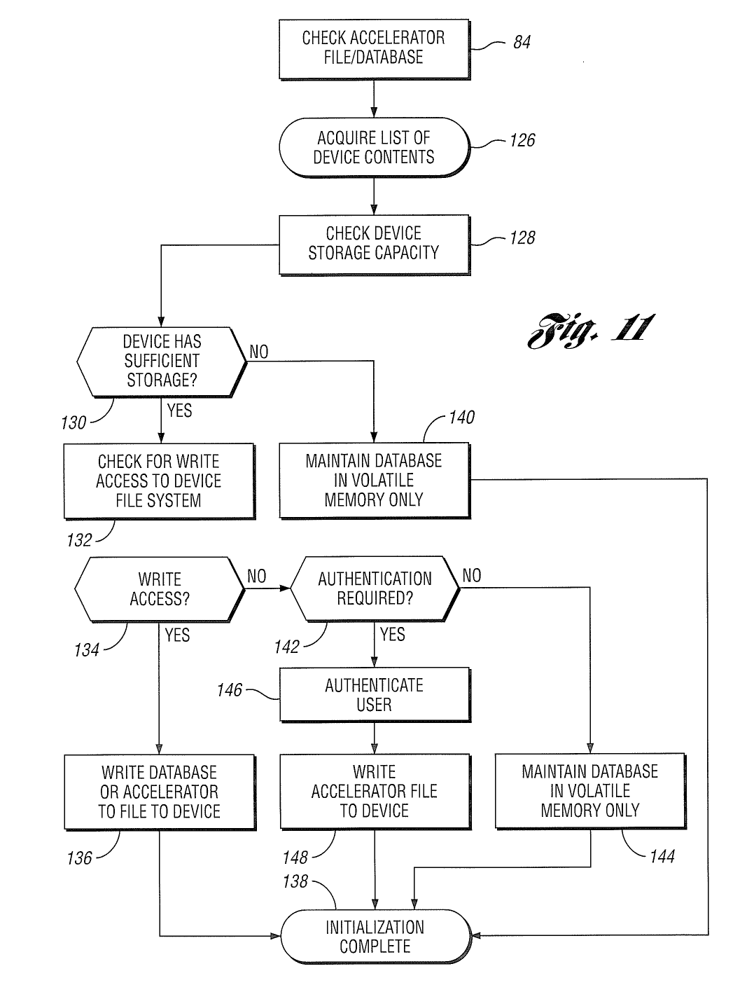

Now referring to FIG. 10, a flow diagram illustrates block 60 of FIG. 8 which depicts the updating of the accelerator file/database. At block 116, the method checks the contents of the accelerator file. As depicted by block 118, the device contents are scanned and compared to the accelerator file data. At block 120, the method determines whether the data is current or up to date. If the data is up to date, the initialization phase is completed as depicted by block 86. If the data requires updating, block 122 occurs wherein the accelerator file is updated based on data from the scan occurring at block 118. In one embodiment, the controller updates the accelerator file by appending the accelerator file or deleting data from the accelerator file.

Now, referring to FIG. 11, a detailed flowchart is provided that illustrates the creation of the accelerator file or database. Accordingly, block 84 illustrates creating the accelerator file or database. Block 126 depicts acquiring a list of the device's contents. Block 128 depicts the method checking the device storage capacity. Accordingly, the method determines whether the device has sufficient storage capacity as shown at block 130. If the method does not have sufficient storage, a block 140 occurs. At block 140, the method stores the accelerator file or database in volatile memory of the controller. After a block 140, block 138 occurs wherein the initialization is complete.

Referring back to block 130, if the device has sufficient storage, a block 132 occurs. As depicted by block 132, the method checks for write access to the device's file system. Accordingly, the method determines whether the multimedia system has write access to the device as shown by block 134. If the method has write access, the multimedia system writes the database or accelerator file to the device as depicted by block 136. Accordingly, the initialization is complete as shown by block 138. Referring back to block 134, if the multimedia system does not have write access, a block 142 occurs. At block 142, the method determines whether authentication is required. If no authentication is required, the system maintains the database or accelerator file in volatile memory. Subsequently, the initialization is complete as illustrated by block 138. Referring back to block 142, if authentication is required, the user is authenticated by block 146. Additionally, the method writes the database or accelerator file to the device as shown by block 148. Consequently, the initialization is complete as depicted by block 138.

While the best mode for carrying out the invention has been described in detail, those familiar with the art to which this invention relates will recognize various alternative designs and embodiments for practicing the invention as defined by the following claims.

What is claimed:

1. A multimedia system for a vehicle that enables a user to access content on a device, the system comprising:
a user interface operable with the vehicle and adapted to receive a query command, wherein the query command is received in a predetermined form, the user interface providing corresponding query results to the user; and
a controller that is operable with the user interface and configured to communicate with the device, the controller, in response to the query command, searching accelerator files containing data pertaining to the content, locating accelerator files that correspond with the query command and providing the data from the corresponding accelerator files to the user interface.

2. The system of claim 1, wherein the controller reads at least a segment of the content and creates the accelerator file based on the segment.

3. The system of claim 2, wherein the controller has a memory and the accelerator file is stored in volatile memory of the controller.

4. The system of claim 2, wherein the controller writes the accelerator file into the memory of the device.

5. The system of claim 4, wherein the controller verifies whether write access is granted or denied prior to writing the accelerator file into the memory of the device.

6. The system of claim 5, wherein the controller determines whether authentication is required if write access is denied.

7. The system of claim 6, wherein the accelerator file is stored in volatile memory of the controller.

8. The system of claim 1, wherein the controller updates the accelerator files by at least one of appending the accelerator files and deleting data from the accelerator files.

9. The system of claim 1, wherein the user interface is a graphical user interface.

10. The system of claim 9, wherein the query results are graphically provided to the user.

11. The system of claim 1, wherein the user interface is a voice control user interface.

12. The system of claim 11, wherein the query results are audibly provided to the user via the user interface.

13. The system of claim 1, wherein the query command received in the predetermined form includes at least one of selecting a criteria from a menu and entering a voice command.

14. A method of operation for a multimedia system on a vehicle that enables access to content located on a device, the method comprising:
receiving a query command through the use of the user interface, wherein the user interface is operable with the vehicle and the query command is received in a predetermined form;
searching accelerator files containing data pertaining to the content;
locating accelerator files that correspond with the query command;
providing the corresponding accelerator file data to the user interface; and
providing the query results to the user.

15. The method of claim 14, further comprising reading at least a segment of the content and creating the accelerator file based on the segment.

16. The method of claim 15, wherein the segment includes a header of the content.

17. The method of claim 15, wherein the controller has a memory and the accelerator file is stored in volatile memory of the controller.

18. The method of claim 15, wherein the controller writes the accelerator file into the memory of the device.

19. The method of claim 18, wherein the controller verifies whether write access is granted or denied prior to writing the accelerator file into the memory of the device.

20. The method of claim 14, wherein the controller updates the accelerator files by at least one of appending the accelerator files and deleting data from the accelerator files.
